(19) United States
(12) Patent Application Publication
(10) Pub. No.: US 2012/0097749 A1
(43) Pub. Date: Apr. 26, 2012

(54) LIGHT THERMOSTAT

(75) Inventors: Tatiana Aleksandrovna Lashina, Eindhoven (NL); Igor Berezhnyy, Eindhoven (NL); Lucas Josef Maria Schlangen, Eindhoven (NL); Johannes Petrus Wilhelmus Baaijens, Eindhoven (NL); Simone Helina Maria Poort, Eindhoven (NL)

(73) Assignee: KONINKLIJKE PHILIPS ELECTRONICS N.V., EINDHOVEN (NL)

(21) Appl. No.: 13/380,531

(22) PCT Filed: Jun. 22, 2010
(86) PCT No.: PCT/IB2010/052826

§ 371 Date: Dec. 23, 2011

(30) Foreign Application Priority Data
Jun. 24, 2009 (EP) 09163663.9

(51) Int. Cl. G05D 23/00; H05B 37/02

(52) U.S. Cl. 236/51; 315/309

(57) ABSTRACT

A basic idea of the invention is to use different properties of light (101), such as e.g. intensity and color temperature, to influence physiological thermoregulating parameters of a vertebrate (102), for example a human being, being exposed to the light. At least one particular physiological thermoregulating parameter (e.g. skin temperature) of an individual is being measured and supplied to a controller (103) for comparison with a desired target value of the measured parameter. The property of light can then be adjusted to regulate the actual value of the thermoregulating parameter of the individual being exposed to the light. Thus, a dynamic device (100) for influencing the thermoregulation of an individual by using different properties of light is provided.

### FIELD OF THE INVENTION

The present invention relates to a lighting control device and system for influencing thermoregulation of a vertebrate. The present invention further relates to a climate control system and methods corresponding to the mentioned devices and systems.

### BACKGROUND OF THE INVENTION

Lighting is known to be an important factor for controlling indoor environment. Light facilitates perception, can create a pleasant atmosphere and provides a powerful stimulus to our biological clock, thus supporting a healthy activity-sleep cycle.

The human circadian (24 hr) rhythm is accompanied by a 24-hour, almost sine wave-shaped, variation of the core body temperature (CBT) of the human body. The peak-to-peak value of the CBT variation is typically some 0.7 degrees centigrade. The CBT minimum usually occurs at night, around 1-2 hours before spontaneous wake-up. Nocturnal darkness is associated with a peak in secretion of the hormone melatonin. Melatonin reinforces darkness-related behavior, which for humans implies sleep. Sleep is associated with lower temperatures while activity is associated with higher temperatures. A temperature difference between distal skin (hand, feet) and proximal skin (thigh, stomach) may promote onset of sleep. For rapid sleep onset it is essential that the body can discharge heat by using distal skin regions to dissipate heat from the core body to the environment, allowing the core body temperature to drop. This demonstrates that thermoregulation can be used as a means to control sleepiness of an individual. Exposure to nocturnal light suppresses nocturnal melatonin secretion, thus influencing thermoregulation as the melatonin peak is usually associated with the minimum in CBT. By influencing the melatonin levels and phase shifting the biorhythm, light has an indirect influence on thermoregulation.

It is less well known that light also has a direct influence on thermoregulation in humans. Bright light exposure decreases the core body temperature, even during exercise. The higher the color temperature of the light source, the stronger this effect, although at high levels saturation of this effect may occur. The CBT lowering effect of the bright light exposure may persist several hours after exposure has ended. Bright light exposure over several hours during the daytime appears to reduce the CBT threshold above which cutaneous vasodilatation and forearm sweating occurs to a lower level.

After daytime bright light exposure, subjects felt less cold during chilly afternoons or evenings. These findings indicate a reduced set point of core body temperature caused by the influence of bright light exposure in the daytime. The reduced CBT set point also has an effect on skin blood flow. In cold environments, the dermal blood flow has to increase to promote heat loss so that the CBT can be kept at a lower level.

Not only the light intensity is known to be thermoregulating, also the color temperature of the light can be used for thermoregulation. When comparing 3000, 5000 and 7500 K lighting, the increase in rectal temperature just after hot bathing (40 C) is greatest under bathroom lighting of 3000 K and the higher value was maintained after bathing. This conforms to the observation that light of a higher color temperature results in a lower set point of the CBT. While bathing, the dermal blood flow has to be low so that the CBT increase due to heat absorption from the bath is minimal. When the CBT set point decreases, the dermal blood flow further decreases in an attempt to minimize heating of the body core. However, upon leaving the hot water, the individual's dermal blood flow quickly rises. This enables an individual to get rid of the excess heat, thus allowing the CBT to decrease to its set point. A lower CBT set point will increase the dermal blood flow after the bath and will reduce the individual's drop in skin temperature after exiting the water.

To conclude, it can be said that the intensity and color temperature of the lighting have a direct influence on thermoregulation of a vertebrate being exposed to the lighting. Scientific results indicate that the set point of the core body temperature decreases with increasing intensity and color temperature.

U.S. Pat. No. 6,554,439 discloses an apparatus for generating artificial light that closely simulates the intensity and spectrum of natural light and other dynamic light conditions. The apparatus includes a collection of light sources of various colors which are controlled by a computer. Attached to the computer is a sensor that measures the spectral qualities of the light produced by the light sources. The sensor sends this information to the computer which adjusts the light sources to generate the desired light conditions. However, the apparatus of U.S. Pat. No. 6,554,439 only measures, feeds back and takes into account spectral qualities of the light emitted by the light sources in order to control the desired light conditions, and thus fails to take into account the above discussed issues related to thermoregulation.

### SUMMARY OF THE INVENTION

It is an object of the present invention to solve, or at least mitigate, the previously discussed problems related to thermoregulation of vertebrates.

This object is achieved by the present invention as defined by the independent claims. Preferred embodiments are defined by the dependent claims.

In a first aspect of the present invention, there is provided a lighting control device for influencing thermoregulation of a vertebrate, which device comprises a receiver arranged to receive a measured value representing at least one physiological thermoregulating parameter of a vertebrate being exposed to at least one light source. Further, the device comprises a controller arranged to generate a control signal for controlling a property of light emitted from the light source(s), in response to the measured value of the physiological thermoregulating parameter, in accordance with a target value of the physiological thermoregulating parameter. The lighting control device further comprises a transmitter arranged to transmit the control signal to the light source(s), wherein the controlled property of light causes the actual value of the physiological thermoregulating parameter of the vertebrate to approach the target value.

In a second aspect of the present invention, there is provided a method of influencing thermoregulation of a vertebrate, which method comprises the step of receiving a measured value representing at least one physiological thermoregulating parameter of a vertebrate being exposed to at least one light source. Further, the method comprises the step of generating a control signal, in response to the measured value of the physiological thermoregulating parameter, for controlling a property of light emitted from the light source(s) in accordance with a target value of the physiological thermoregulating parameter. The method further comprises the step of transmitting the control signal to the light source(s), wherein the controlled property of light causes the actual value of the physiological thermoregulating parameter of the vertebrate to approach the target value.

In a third aspect of the present invention, there is provided a lighting control system comprising the lighting control device of claim 1, which system further comprises a sensor attachable to the vertebrate for measuring the at least one physiological thermoregulating parameter and transmitting the value representing the physiological thermoregulating parameter to the receiver.

In a fourth aspect of the present invention, there is provided a lighting control system comprising the lighting control device of claim 1, which system further comprises the at least one light source.

Further, the lighting control system may comprise the sensor of the third aspect as well as the light source(s) of the fourth aspect.

In a fifth aspect of the present invention, there is provided a climate control system being connectable to the lighting control device of claim 1, which system further comprises a climate control device being arranged to be responsive to the control signal generated by the controller of the lighting control device, wherein characteristics of fluid discharged by the climate control device are adapted in accordance with the controlled property of light.

In a sixth aspect of the present invention, there is provided a method of controlling a climate control device, which method comprises the step of adapting characteristics of fluid discharged by a climate control device in response to the control signal, whereby said characteristics are adapted in accordance with the controlled property of light.

A basic idea of the invention is to use different properties of light such as e.g. intensity and color temperature to influence physiological thermoregulating parameters of a vertebrate, for example a human being, being exposed to the light. At least one particular physiological thermoregulating parameter (e.g. skin temperature) of an individual is measured and supplied to a controller for comparison with a desired target value of the measured parameter. The property of light can then be adjusted to regulate the actual value of the thermoregulating parameter of the individual being exposed to the light. Thus, a dynamic device for influencing the thermoregulation of an individual by using different properties of light is provided.

Assuming e.g. that the measured physiological thermoregulating parameter is skin temperature and that the target value for the skin temperature is set to 36° C. If a measured value of the skin temperature of an individual is, say, 40° C., the intensity and/or color temperature of the light to which the individual is exposed could be increased, which generally lowers the skin temperature of the individual. By continuously measuring the physiological thermoregulating parameter and adjusting the property of light accordingly, the actual value of the parameter will approach the target value.

There are numerous physiological thermoregulating parameters which could be measured and fed back to the lighting control device of the present invention, all of which also may be influenced by the exposure to light; these physiological thermoregulating parameters include skin temperature, core body temperature, Electroencephalographical (EEG) signals, skin blood flow, skin impedance, heart rate, respiration volume and/or frequency, skin humidity, produced wattage (measured e.g. by a fitness device such as bicycle), physical activity, etc.

Further, there are numerous properties of light which could be adjusted, all of which also influence the actual value of the physiological thermoregulating parameter of the individual being exposed to the light; these properties of light include intensity, color temperature, spectral composition, brightness, duration of emission, hue, saturation, etc.

Colors giving a feeling of elevated ambient temperatures are colors between red and yellow (e.g. red, orange, yellow-orange, pure yellow) on the hue circle; i.e. in terms of dominant wavelength λ_{d}, colors with 576 nm<λ_{d}<700 nm. Colors giving a feeling of lower ambient temperatures are colors between green and blue on the hue circle (e.g. green, cyan, blue); i.e. in terms of dominant wavelength λ_{d}, colors with 460 nm<λ_{d}<520 nm.

Further, to attain an increased or decreased perceived ambient temperature, the colors need to have a sufficient level of saturation. These levels are typically defined by the CIE1931 chromaticity diagram, which is known to a skilled person. Moreover, the level of saturation for a certain hue is also determined by the choice of the reference white point.

Choosing the white point in the color system at 6500 K (daylight) would be a universal choice, suitable for both warm and cool colors. This could also be used for the ambient white lighting present in an indoor space. However, the experience of “warm” or “cool” hues can be enhanced by also adjusting the color temperature of the ambient white light.

The present invention thus helps vertebrates to adapt more easily to ambient temperature conditions. The invention enables a very broad field of applications and is a powerful tool for increasing the feeling of well-being or level of achievement in humans.

Further, a great advantage of the present invention is that energy consumption of climate and/or heating control systems such as air-conditioners can be decreased, since a human being perceives the ambient temperature as higher or lower when he is exposed to light having certain characteristics, for example a low color temperature. Thus, by exposing an individual to light having a low color temperature, it is possible to lower the ambient temperature and still have the individual perceive the ambient temperature as being the same as it was before actually lowering it. Further, by exposing an individual to light having a high color temperature, the individual will perceive the ambient temperature as cooler, thereby lowering the need for air-conditioning systems. Hence, great energy savings are possible for heating and climate systems.

It is further noted that the age of the world population is steadily increasing. The temperature comfort zone of elderly people is smaller as compared to younger people, which calls for a more widespread use of air-conditioning systems. In general, elderly are more troubled by heat or cold than younger people, which is partially due to their reduced ability to sweat but also other physiological changes associated with aging make their heat exchange with the environment less efficient. The present invention facilitates a better thermoregulation of elderly people, which will improve their quality of life under warm or hot conditions.

Further provided is a lighting control system incorporating the above described lighting control device and further comprising a sensor which is attachable to the vertebrate for measuring a physiological thermoregulating parameter and transmitting the value representing the parameter to the receiver of the lighting control device for further control of light properties. This lighting control system promotes, from the individual's point of view, an automated control of light properties for influencing the individual's thermoregulation.

In a further embodiment, the sensor is arranged to transmit the target value of said physiological thermoregulating parameter to the receiver, and in yet a further embodiment, the sensor is provided with a user interface via which the individual may selectively enter one or more target values to be transmitted to the lighting control device receiver. In another embodiment, a particular physiological thermoregulating parameter to be measured can be entered by an individual via the user interface.

As can be seen, further advantages of the inventive lighting control device and lighting control system include personalization, automatic operation and selectable user preferences. Undoubtedly, the most valuable merits amongst the large variety of advantages to be obtained with the intelligent thermoregulating system of the present invention will be (a) increased comfort during warm days, (b) better heat loss while exercising, and (c) lower air-conditioning energy consumption by expanding the temperature comfort zone of individuals, as a result of adequate light exposure.

Further provided is a climate control system being connectable to the previously described inventive lighting control device and further comprising a climate control device for intelligent climate control. Thus, the lighting control device of the present invention is combined with a HVAC (heating, ventilating and air conditioning) device, also referred to as a climate control device. In the inventive climate control system, the output of the HVAC device is responsive to the controlled property of light. For instance, assuming that the color of the light source(s) of the lighting system is adjusted towards the red-yellow area of the color scale, the output temperature of the climate control system may be lowered, since a “warmer” color of light will result in a higher perceived ambient temperature for the individual. Parameters of the climate control system other than temperature, such as e.g. humidity, air flow, purity, etc. may alternatively be adjusted in response to the controlled property of light. Thus, the climate control device is arranged to be responsive to the control signal generated by the controller of the lighting control device, wherein characteristics of fluid discharged by the climate control device are adapted in accordance with the controlled property of light.

Most of the commercially available HVAC systems are optimal in terms of energy saving and perform fairly well. However, their major drawback is that they are designed to operate in response to purely physical parameters such as temperature and/or humidity. Their weakness is that they do not employ human perception of light in order to become even more efficient in terms of energy saving. With this particular climate control system, human perception of light is taken into account to control the HVAC device output, which in turn allows greater energy efficiency.

It is noted that the light sources used can be any one of LED, incandescent, halogen, fluorescent or metal-halide, etc. Of course, more than one light source can be used in the lighting control system of the present invention.

Environments in which the present invention advantageously may be applied include:

office environments having climate control using heating and cooling systems. The demand for cooling functions decreases as people are less bothered by heat (e.g. when exposed to lighting of high intensity or temperature color), which may be used to reduce energy consumption during hot days,

care institutions & living areas for senior citizens. The relatively small temperature comfort zone of seniors is increased, reducing the risk of hyperthermia (due to summer heat) or hypothermia (due to winter cold),

fitness establishments; for higher performance and less heat exhaustion; wellness; many aspects can be influenced, steering temperature gradients during bath/sauna use, reducing blood pressure by increasing dermal blood flow, influencing digestion, etc; homes; evening/bedside lighting to facilitate falling asleep in order to wake up and get out of bed with less thermal discomfort.

It is noted that the invention relates to all possible combinations of features recited in the claims. Further features and advantages of the present invention will become apparent when studying the appended claims and the following description. Those skilled in the art will realize that different features of the present invention can be combined to create embodiments other than those described in the following.

### BRIEF DESCRIPTION OF THE DRAWINGS

These and other aspects of the present invention will now be described in more detail, with reference to the appended drawings showing embodiments of the invention.

FIG. 1 shows a lighting control device according to an embodiment of the invention.

FIG. 2 shows a lighting control system according to an embodiment of the present invention, which lighting control system comprises the lighting control device illustrated in FIG. 1.

FIG. 3 shows a climate control system according to an embodiment of the present invention, which climate control system comprises the lighting control device illustrated in FIG. 1.

### DETAILED DESCRIPTION

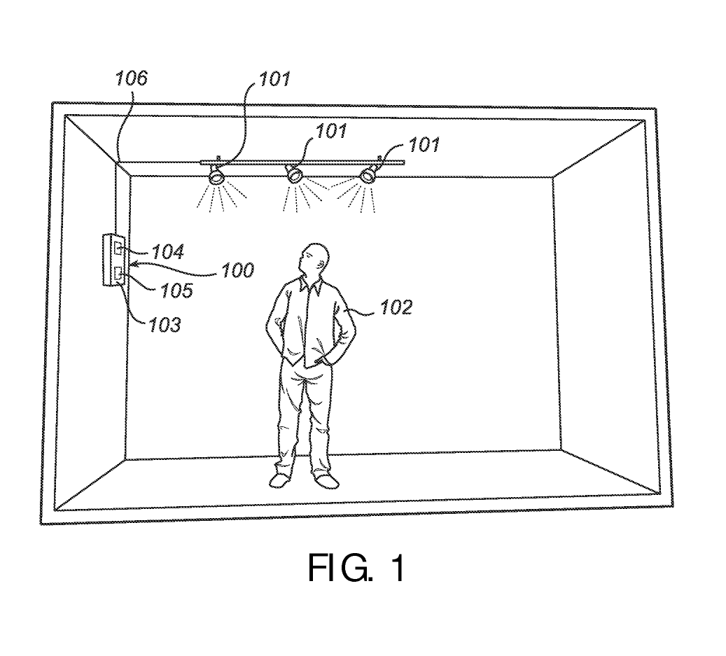

FIG. 1 shows an embodiment of a lighting control device 100 according to the present invention. An individual 102 is exposed to emission of light from a number of light sources 101 emitting light having a certain characteristic. The lighting control device 100 further comprises a receiver 103 arranged to receive a measured value representing at least one physiological thermoregulating parameter of the individual. In the example given in the following, the measured physiological thermoregulating parameter of the individual is skin temperature. The instantaneous measured value of the skin temperature is in this particular example 40° C.

The lighting control device 100 further comprises a controller 104 for controlling, by means of a generated control signal and in accordance with a parameter target value, a property of light emitted from the light sources 101 in response to the measured value of the physiological thermoregulating parameter. The control signal is transmitted by transmitter 105 incorporated in the lighting control device via leads 106 to cause the actual value of the skin temperature to approach the target value, which in this particular example is set to 36° C. Thus, the controller 104 adjusts e.g. the intensity and/or color temperature of the light sources to which the individual is exposed. When the intensity and/or color temperature of the light is/are increased, the skin temperature decreases. By continuously measuring an instantaneous value of the individual's skin temperature and adjusting the light property in response thereto, the actual value of the skin temperature will approach the target value of 36° C. In this particular embodiment, the individual may measure the physiological thermoregulating parameter himself, e.g. with a thermometer, and provide the receiver with an instant value, for example via a keypad (not shown) connected to the receiver 103. It is to be noted that FIG. 1 functionally illustrates an embodiment of the present invention. For instance, the receiver 203 and transmitter 205 could be combined into one single transceiver unit.

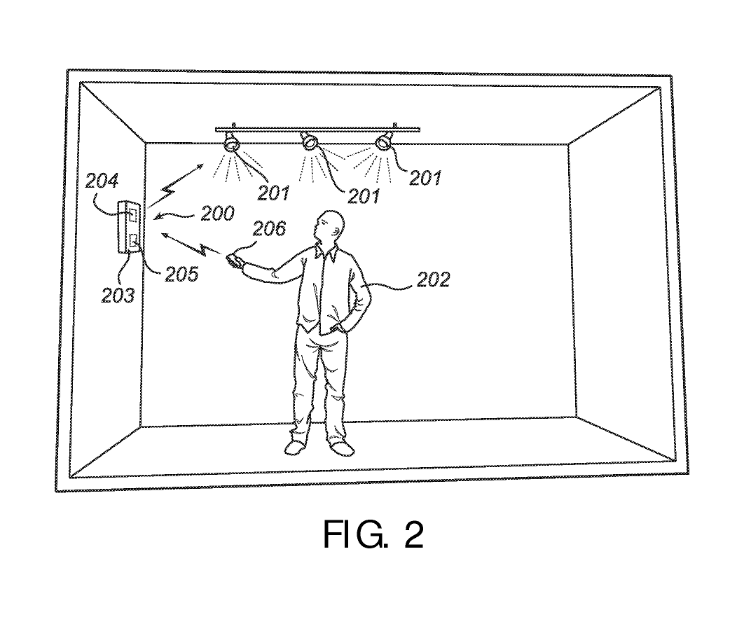

FIG. 2 shows a lighting control system according to an embodiment of the present invention, which lighting control system comprises the lighting control device illustrated in FIG. 1. A sensor 206 is in communication with the lighting control device 200, which sensor is attached to the individual 202 and included for measuring the physiological thermoregulating parameter and for wirelessly transmitting the measured value to the receiver 203. It is further possible that a desired target value is transmitted with the measured instantaneous value. The controller 204 controls a property of light emitted from the light sources 201 in accordance with the measured instantaneous value and the target value. This property can be controlled via leads, as shown in FIG. 1, or via wireless transmission through transmitter 205. The sensor 206 of FIG. 2 may e.g. be implemented as a wristlet, possibly combined with an exercise device such as a pulse clock.

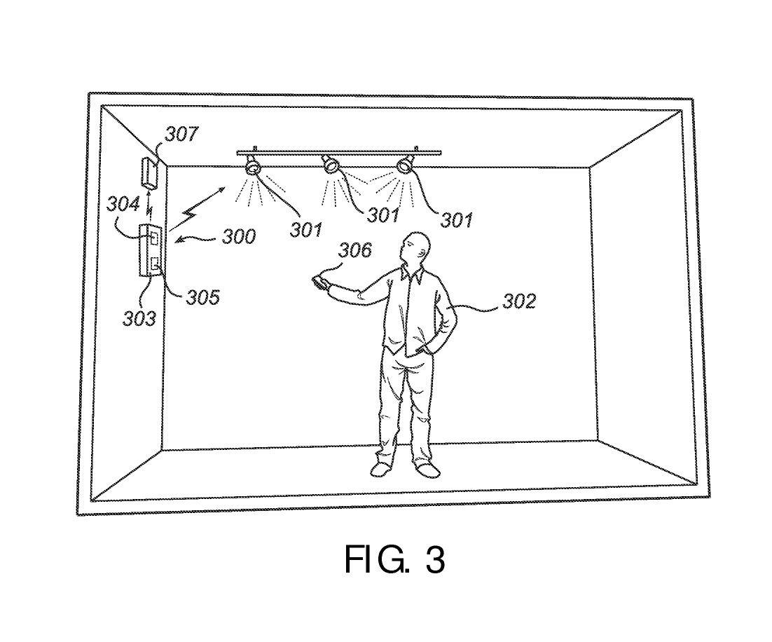

FIG. 3 shows a climate control system according to an embodiment of the present invention, which climate control system is connectable to the lighting control device illustrated in FIG. 1. In the climate control system illustrated in FIG. 3, the lighting control device illustrated in FIGS. 1 and 2 is combined with a climate control device. In a first alternative, the inventive lighting control device is interconnected (possibly after minor modifications) with an existing climate control device being already commercially available. In a second alternative, a climate control device is included in the lighting control system of FIGS. 1 and 2. The functional description set forth in the following is valid for both alternatives. The lighting control device 300 communicates with a number of light sources 301 emitting light having a certain characteristic, to which the individual 302 is exposed. The receiver 303 of the lighting control device is arranged to receive, from the sensor 306, a measured value representing a physiological thermoregulating parameter of the individual. As in the previous example, the measured physiological thermoregulating parameter of the individual is skin temperature. The instantaneous measured value of the skin temperature is in this particular example 36° C.

The lighting control device 300 further comprises a controller 304 for controlling, in accordance with the parameter target value, a property of light emitted from the light sources 301 in response to the measured value of the physiological thermoregulating parameter. The light sources are controlled by means of a control signal via wireless communication through the transmitter 305 to cause the actual value of the skin temperature to approach the target value. Assuming that the target value in this particular example is 36° C., i.e. the same as the measured value, it is really not necessary to adjust lighting properties to make the measured value approach the target value. However, for energy saving purposes, a color property can be controlled by means of transmitting the lighting property control signal to the light sources. As previously described, colors giving a feeling of elevated ambient temperatures are colors between red and yellow, i.e. colors with 576 nm<λ_{d}<700 nm. By causing the light sources 301 to emit red/orange/yellow light, it is possible to lower the temperature of the air output by climate control device 307, and still have the individual 302 perceive the ambient temperature as being constant. Thus, the transmitter 305 wirelessly communicates the control signal to the climate control device 307 to lower the temperature of discharged air. In the case where the climate control device 307 is comprised in the lighting control device 300, the control signal is in general not communicated via a wireless interface, as the climate control device 307 in that case typically is comprised in the same housing as the lighting control device 300.

The climate control device may comprise a user interface via which a user can program desired climate parameters, e.g. a desired set temperature of 20° C. Further, the climate control device may comprise a control algorithm for controlling deviations from the temperature set by the user by automatically lowering the set temperature of discharged air when warming up occurs, or raising the set temperature of discharged air when cooling with air-conditioners, while compensating for the deviations by having the controller adjust light properties.

The illustrated lighting control device/system and climate control system typically comprise one or more microprocessors or some other device with computing capabilities, e.g. an application specific integrated circuit (ASIC), a field programmable gate array (FPGA), a complex programmable logic device (CPLD), etc., in order to control light source properties and climate control device output, while executing appropriate downloadable software stored in a suitable storage area, such as a RAM, a Flash memory or a hard disk. For intercommunication to be possible, wireless communication interfaces are provided.

The person skilled in the art realizes that the present invention by no means is limited to the preferred embodiments described above. On the contrary, many modifications and variations are possible within the scope of the appended claims. For example, the thermoregulating lighting system can be implemented in many different ways, e.g. as a stand-alone lighting device, in a personal cap, in a car visor, in a pair of glasses, in the frame of a

PC monitor, or in a general lighting system, etc. Another implementation may be based on the combination of the thermoregulating lighting system with a backlight being part of a liquid-crystal display.

1. A lighting control device for influencing thermoregulation of a vertebrate, said device comprising:
a receiver arranged to receive a measured value representing at least one physiological thermoregulating parameter of a vertebrate being exposed to at least one light source;
a controller arranged to generate, in response to said measured value of the physiological thermoregulating parameter, a control signal for controlling a property of light emitted from said at least one light source in accordance with a target value of said physiological thermoregulating parameter; and
a transmitter Arranged to transmit said control signal to said at least one light source, wherein the controlled property of light causes the actual value of the physiological thermoregulating parameter of the vertebrate to approach said target value.

2. The lighting control device of claim 1, wherein the physiological thermoregulating parameter is any one of:
skin temperature, core body temperature, EEG, skin blood flow, skin impedance, heart rate, respiration volume and/or frequency, skin humidity, produced wattage, physical activity.

3. The lighting control device of claim 1, wherein the controlled property of light is any one of:
intensity, color temperature, spectral composition, brightness, duration of emission, hue, saturation.

4. A lighting control system comprising the lighting control device of claim 1, said system further comprising:
said at least one light source.

5. A lighting control system comprising the lighting control device of claim 1, said system further comprising:
a sensor attachable to the vertebrate for measuring said at least one physiological thermoregulating parameter and transmitting the value representing the physiological thermoregulating parameter to the receiver.

6. The lighting control system of claim 5, wherein the sensor further is arranged to transmit the target value of said physiological thermoregulating parameter to the receiver.

7. The lighting control system of claim 6, wherein the sensor further is arranged with a user interface via which said target value can be supplied to the sensor.

8. The lighting control system of claim 5, wherein the sensor further is arranged with a user interface via which a particular physiological thermoregulating parameter to be measured can be entered.

9. The lighting control system of claim 5, wherein
said receiver further is arranged to receive a measured value representing ambient temperature; and
said controller further is arranged to consider the measured ambient temperature when controlling said property of light.

10. A climate control system arranged to be connectable to the lighting control device of claim 1, said system further comprising:
a climate control device being arranged to be responsive to the control signal generated by the controller of the lighting control device, wherein characteristics of fluid discharged by the climate control device are adapted in accordance with the controlled property of light.

11. A method of influencing thermoregulation of a vertebrate, said method comprising the steps of:
receiving a measured value representing at least one physiological thermoregulating parameter of a vertebrate being exposed to at least one light source;
generating a control signal, in response to said measured value of the physiological thermoregulating parameter, for controlling a property of light emitted from said at least one light source in accordance with a target value of said physiological thermoregulating parameter; and
transmitting said control signal to said at least one light source, wherein the controlled property of light causes the actual value of the physiological thermoregulating parameter of the vertebrate to approach said target value.

12. The method of claim 11, wherein the step of receiving a measured value further comprises the step of:
measuring a value representing at least one physiological thermoregulating parameter of a vertebrate being exposed to at least one light source.

13. The method of claim 11, further comprising the step of:
adapting characteristics of fluid discharged by a climate control device in response to said control signal, wherein said characteristics are adapted in accordance with the controlled property of light.

14. A computer program product comprising computer-executable components for causing a device to perform the steps recited in claim 11 when the computer-executable components are run on a processing unit included in the device.
